(19) United States
(12) Patent Application Publication
(10) Pub. No.: US 2006/0195502 A1
(43) Pub. Date: Aug. 31, 2006

(54) Group delay compensation using IFFT filters

(75) Inventors: Anirudh Kailash Sureka, Nanuet, NY (US); Peter J. Pupalaikis, Ramsey, NJ (US)

Correspondence Address: LECROY CORPORATION, 700 CHESTNUT RIDGE ROAD, CHESTNUT RIDGE, NY, 10977, US

(73) Assignee: LeCroy Corporation, Chestnut Ridge, NY (US)

(21) Appl. No.: 11/264,530

(22) Filed: Nov. 1, 2005

Related U.S. Application Data
(60) Provisional application No. 60/656,629, filed on Feb. 25, 2005.

(51) Int. Cl. G06F 17/14

(52) U.S. Cl. 708/404

(57) ABSTRACT

A method, computer program, and apparatus for compensating for group delay. The method comprises the steps of generating a raw step response of a system, differentiating the raw step response to generate an impulse response of the system, windowing the impulse response and taking a Fast Fourier Transform (FFT) of the windowed impulse response to generate a frequency response of the system. A phase response of the system is then calculated from the frequency response, and an IFFT Group Delay filter is defined in accordance with the phase response of the system. Finally, the IFFT Group Delay filter is applied to the raw step response.

### CROSS REFERENCE TO RELATED APPLICATIONS

This application claims the benefit of U.S. Provisional Patent Application Ser. No. 60/656,629 titled Group Delay Compensation Using the IFFT Filters, filed Feb. 25, 2005, the entire contents thereof being incorporated herein by reference.

### BACKGROUND OF THE INVENTION

This invention pertains generally to sampled-data systems: systems containing at least a subsystem consisting of an analog input signal, some analog hardware, an analog-to-digital converter (ADC), a processing element such as a digital signal processor (DSP) and a processed output signal in digital form.

This invention pertains specifically to such systems in which the phase characteristic is sub optimum. Phase is of particular interest because while magnitude response specifications can often be stated clearly, phase specifications often cannot. Magnitude response specifications are often made directly in the frequency domain. In other words, the specifications are a specific statement of desired magnitude response at particular frequencies. Filters designed to compensate magnitude response are most often specified, designed, and evaluated in the frequency domain. However, this is not necessarily the case for phase. Generally speaking, the requirement for phase response is that it be linear, which in other words is a constant group delay. This is because group delay is just another way of looking at phase. Group delay at a particular frequency is the time delay experienced by that particular frequency component as it passes through a system. Linear, negative phase means that the group delay is a constant at all frequencies (i.e. the entire signal experiences only a time shift as it passes through the system). The statement of group delay and phase are essentially equivalent and both will be used interchangeably.

### SUMMARY OF THE INVENTION

In accordance with the invention, in order to compensate for the Group Delay of the system, first IFFT GD (Inverse Fast-Fourier Transform Group Delay) filters are made. This results in an output which has a linear phase. Then a stage of IIR GD (Infinite Impulse Response Group Delay) filter is added to the IFFT GD filters such that the output through this filter is an optimized step response, with desired risetime, overshoot and preshoot characteristics.

Still other objects and advantages of the invention will in part be obvious and will in part be apparent from the specification and the drawings.

The invention accordingly comprises the several steps and the relation of one or more of such steps with respect to each of the others, and the apparatus embodying features of construction, combination(s) of elements and arrangement of parts that are adapted to effect such steps, all as exemplified in the following detailed disclosure, and the scope of the invention will be indicated in the claims.

### BRIEF DESCRIPTION OF THE DRAWINGS

For a more complete understanding of the invention, reference is made to the following description and accompanying drawings, in which:

FIG. 1 is a step response without any group delay filtering;

FIG. 2 is a group delay plot for the output waveform of FIG. 1;

FIG. 3 displays the windowed impulse response for the step response of FIG. 1;

FIG. 4 displays the output step response after passing the raw step through an IFFT filter;

FIG. 5 displays a group delay of a filtered step of FIG. 4;

FIG. 6 displays a step response in accordance with the invention;

FIG. 7 displays the group delay of step of FIG. 6; and

FIG. 8 is a flowchart diagram depicting processing in accordance with the invention.

### DETAILED DESCRIPTION OF THE PREFERRED EMBODIMENTS

A detailed description of the invention will now be provided, making reference to the figures and providing details of the calculations.

To generate the IFFT group delay compensation filters in accordance with the invention, the phase response of the system has to be measured. This measurement can be made by either by using the step response of the system to calculate the phase response of the system, or by measuring the phase response of the system directly with a Vector Network Analyzer (VNA). In a preferred embodiment of the invention, the step response is used to calculate the phase response of the system, although the alternate measurement technique would also be acceptable.

A step response of a system is defined as the output of the system generated in response to an input signal shaped as an ideal step. In practical situations, however, the step output from any step generator that is to be used as an input signal to the system is far from ideal due to practical limitations of electronics. In order to generate the true step response of the system, the characteristics of such a non-ideal step input should be removed via calibration of the input step signal. This calibration can be performed by deconvolving the step generator's response from the step response of the system and then convolving the with the second order critically damped step response. The details of this process are set forth in U.S. patent application Ser. No. 10/678,374, titled “Digital Group Delay Compensator”, the entire contents thereof being incorporated herein by reference.

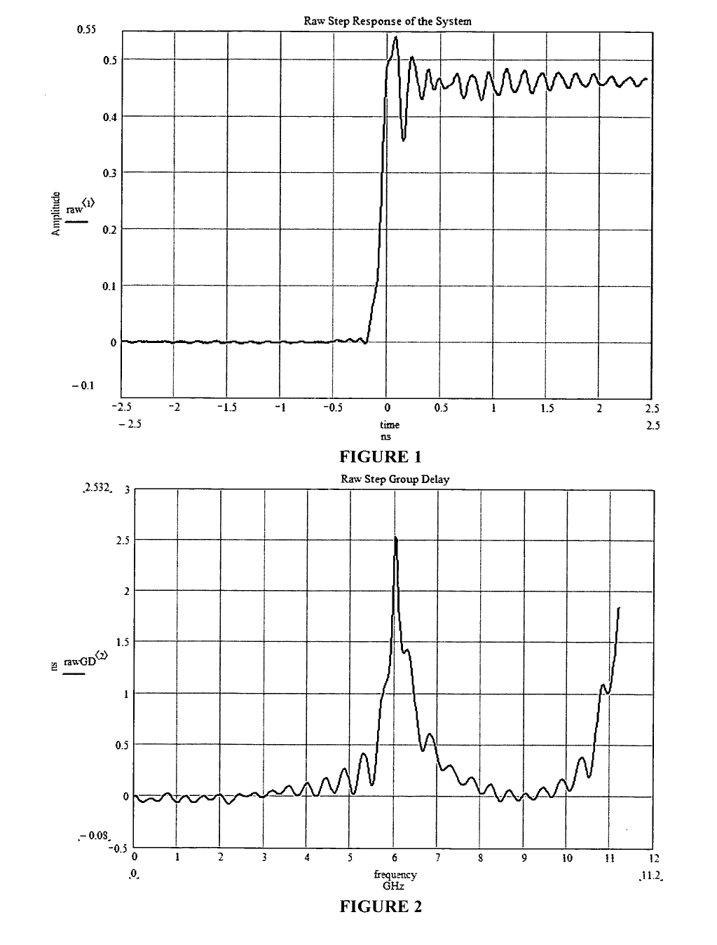

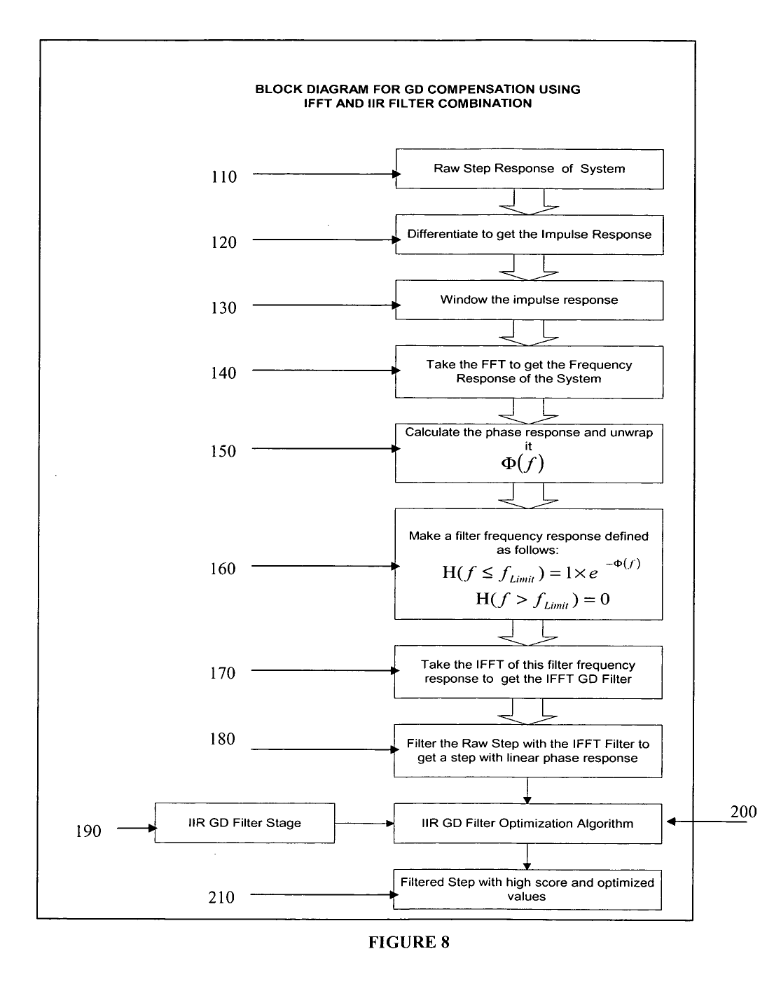

To reduce random noise in the system's step response, the step response is averaged over multiple acquisitions, without changing the input signal. The averaged and centered system step response may then be passed through one or more other filters as required to correct for magnitude response anomalies. As the IFFT Group Delay (GD) Filters and the IIR GD filters correct the phase response of the system without correcting for the magnitude response, any correction to the magnitude response has is performed by an additional set of filters. The waveform output is then used as the raw system step response, shown in FIG. 1 and shown by step 110 in FIG. 8. Such a step response from this additional set of filters is denoted as xₛₜₑₚ in the following set of equations. Also generated at this step is a graph depicting a raw step group delay, as shown in FIG. 2.

As per step 120 in FIG. 8 differentiate the step to get the system's impulse response according to the following equation 1.

$${x}_{impulse} = \frac{ⅆ {x}_{step}}{ⅆ t} \\ {x}_{impulse} [ i ] = \frac{{x}_{step} [ i + 1 ] - {x}_{step} [ i ]}{T} \\ for i = 0 … N 2 \\ where T = sample period of the sampled step response {x}_{step} \\ N = number of points in the step waveform \qquad Equation 1$$

To ensure the same number of points in the impulse response as the step response the last point of the impulse response is reused. While this is not a necessity it is a convenience that same number of points exist, thus making further processing easier.
xᵢₘₚₗᵤₛₑ[N−1]=xᵢₘₚᵤₗₛₑ[N−2] Equation 2

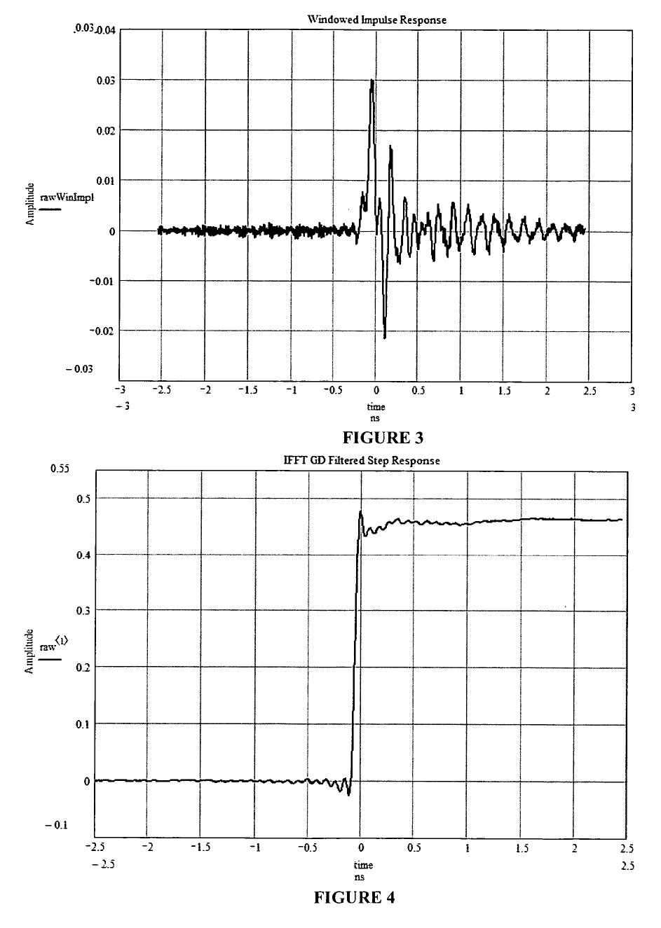

As per step 130 of FIG. 8 a Kaiser-Bessel window is applied to the impulse response as given by Equation 4. This window is given by Equation 3. FIG. 3 displays the windowed impulse response. Of course any other suitable window may be applied.

$$\begin{matrix}{w}_{n} = \frac{{I}_{0} [ π α \sqrt{1 - {[ \frac{n - \frac{N - 1}{2}}{N / 2} ]}^{2}} ]}{{I}_{0} ( π α )} \\ for n = 0 … N - 1 \\ where α = 0.5 \\ {I}_{0} = zeroth order Bessel function & Equation 3 \\ {x}_{impulse} = {x}_{impulse} \cdot w & Equation 4\end{matrix}$$

Processing then continues to step 140 where the DFT (Discrete Fourier Transform) of this windowed impulse response is taken. This calculates a system frequency response to an input critically damped second order step, X The positive spectrum is calculated in Equation 5 below. As xᵢₘₚᵤₗₛₑ is a real signal, the spectrum for negative frequencies is a complex conjugate of the positive spectrum, which can be similarly calculated.

$$X [ k ] = {\sum }_{n = 0}^{N - 1} {x}_{impulse} [ n ] \cdot {ⅇ}^{\frac{- 2 π jkn}{N}} \\ for k = 0 … ( N - 1 ) / 2 \qquad Equation 5$$

Referring next to step 150 of FIG. 8, the phase response of the system is calculated by taking the argument of the complex frequency response. The phase response is then unwrapped.
Φ[k]=Arg(X[k]) Equation 6

Processing then continues to step 160 of FIG. 8, wherein the IFFT GD filter frequency response is derived from the phase response of the system. To correct for the system phase response, the filter frequency response is defined as unity magnitude and negative phase response up to a predetermined limit frequency, and zero beyond this frequency. The magnitude is unity as the IFFT GD Filter should only correct for the phase response without affecting the magnitude response of the system. The predetermined limit frequency for the system is the frequency where the system frequency response has reached the noise floor and the phase response of the system is arbitrary. Equation 7 defines the frequency response of the IFFT GD Filter.
H[k]=1×e^{-Φ[k]} for f<f_{Limit}
H[k]=0 for f>f_{Limit} Equation 7
where Φ=phase in radians

f=k*Fs/N=vector of frequency values

f_{Limit}=frequency after which magnitude response of the system has reached the noise floor.
By taking the IDFT (Inverse Discrete Fourier Transform) of the full spectrum as per step 170 of FIG. 8, the IFFT GD filter is designed.

$$h [ n ] = \frac{1}{N} {\sum }_{k = 0}^{N - 1} H [ k ] \cdot {ⅇ}^{\frac{2 π jkn}{N}} \\ for n = 0 … N - 1 \qquad Equation 8$$

Referring next to step 180 of FIG. 8, the IFFT GD filter is applied to the raw step response displayed in FIG. 1. The filtered step has a linear phase response as shown in FIG. 4, and thus includes equal amounts of pre-shoot and overshoot, as is shown. FIG. 5 displays the group delay of the filtered step. It can be seen that the group delay is reasonably flat for all frequencies which implies that the phase response is reasonably linear. Comparing FIG. 5 with FIG. 2, it can be seen that the 2.5 ns delay at 6 GHz is completely eliminated by applying the IFFT GD filter. Thus while this produces an acceptable response, in a preferred embodiment, additional processing is performed.

Preshoot in a step response suggests non-causality. Practical analog electronics systems are causal in nature. To provide a response that truly simulates a causal system-like response, preshoot must be reduced until it is negligible, at the cost of increasing the overshoot. This process is performed by applying the IIR GD filter, as set forth in step 190 of FIG. 8.

There are no predefined parameters for this filter. A search and evaluate strategy is employed to generate filter coefficients that result in a filter that results in an optimal output step response. The optimality is evaluated with respect to risetime, overshoot and preshoot values of the filtered output step response. An algorithm used to generate this IIR GD filter are is provided in previously mentioned pending U.S. patent application Ser. No. 10/678,374, titled “Digital Group Delay Compensator”, the entire contents of which are hereby incorporated by reference.

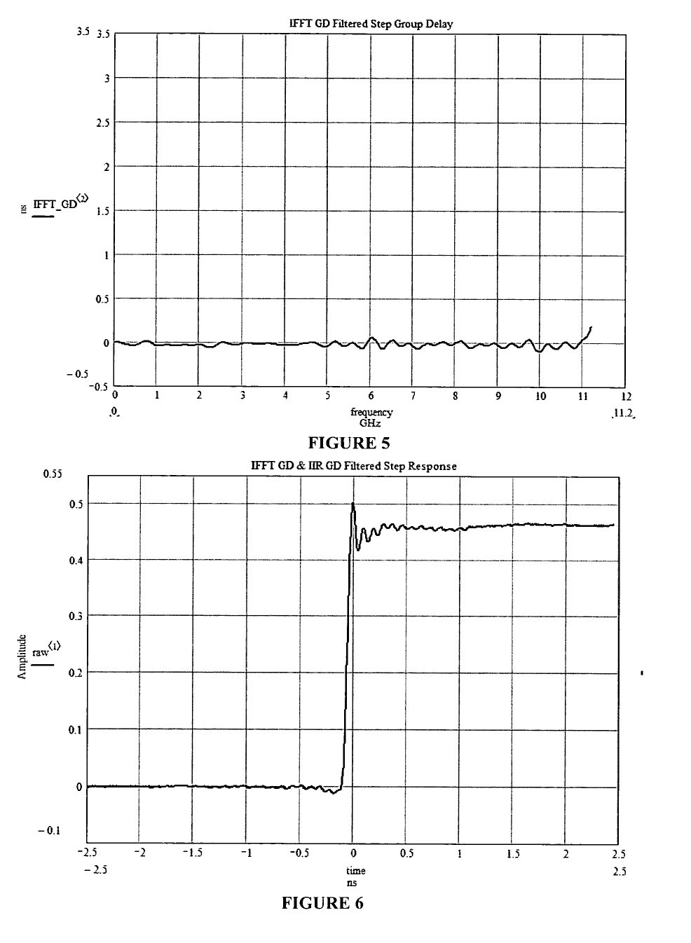

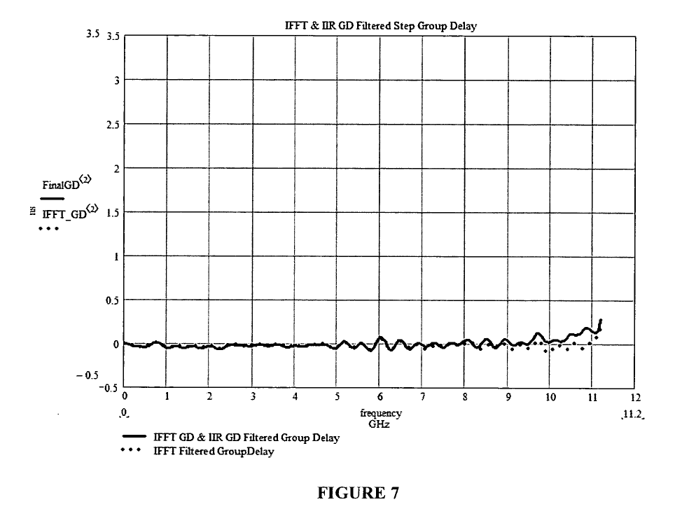

The IIR GD filter designed by using the above algorithm is used to filter the IFFT GD filtered step as per step 210 of FIG. 8. The final output step response is displayed in FIG. 6. The group delay for the same is given in FIG. 7, where it is also compared with the IFFT GD filtered group delay. It can be seen that additional delay has been added to the high frequency (9-11.2 GHz). This is done so that the output step shows optimal values of preshoot, overshoot and risetime. The output step looks as if generated form a more causal apparatus.

Thus by employing two different techniques, first the design and application of IFFT GD filter to get a linear phase response and second the design and application of the IIR GD filter, optimal phase response is obtained.

It will thus be seen that the objects set forth above, among those made apparent from the preceding description, are efficiently attained and, because certain changes may be made in carrying out the above method and in the construction(s) set forth without departing from the spirit and scope of the invention, it is intended that all matter contained in the above description and shown in the accompanying drawings shall be interpreted as illustrative and not in a limiting sense.

It is also to be understood that the following claims are intended to cover all of the generic and specific features of the invention herein described and all statements of the scope of the invention which, as a matter of language, might be said to fall there between.

What is claimed:

1. A method for compensating for group delay, comprising the steps of:
generating a raw step response of a system;
differentiating the raw step response to generate an impulse response of the system;
windowing the impulse response;
taking a Fast Fourier Transform (FFT) of the windowed impulse response to generate a frequency response of the system;
calculating a phase response of the system from the frequency response;
defining a IFFT Group Delay filter in accordance with the phase response of the system; and
applying the IFFT Group Delay filter to the raw step response.

2. The method of claim 1, further comprising the step of applying an IIR Group delay filter to the IFFT Group Delay filtered step response.

3. The method of claim 1, wherein the raw step response is generated by averaging a step response over multiple acquisitions of a waveform.

4. The method of claim 1, further comprising the step of correcting a magnitude of the raw step response.

5. The method of claim 1, wherein the windowing of the impulse response is performed in accordance with a Kaiser-Bessel window.

6. A computer program for use in sampled-data system, the computer program including instructions for:
generating a raw step response of a system;
differentiating the raw step response to generate an impulse response of the system;
windowing the impulse response;
taking a Fast Fourier Transform (FFT) of the windowed impulse response to generate a frequency response of the system;
calculating a phase response of the system from the frequency response;
defining a IFFT Group Delay filter in accordance with the phase response of the system; and
applying the IFFT Group Delay filter to the raw step response.

7. The computer program of claim 6, further comprising an instruction for applying an IIR Group delay filter to the IFFT Group Delay filtered step response.

8. The computer program of claim 6, wherein the raw step response is generated by averaging a step response over multiple acquisitions of a waveform.

9. The computer program of claim 1, further comprising an instruction for correcting a magnitude of the raw step response.

10. The computer program of claim 1, wherein the windowing of the impulse response is performed in accordance with a Kaiser-Bessel window.

11. A sampled data system that compensates for group delay, comprising:
means for generating a raw step response of a system;
means for differentiating the raw step response to generate an impulse response of the system;
means for windowing the impulse response;
means for taking a Fast Fourier Transform (FFT) of the windowed impulse response to generate a frequency response of the system;
means for calculating a phase response of the system from the frequency response;
means for defining a IFFT Group Delay filter in accordance with the phase response of the system; and
means for applying the IFFT Group Delay filter to the raw step response.

12. The sampled data system of claim 11, further comprising the step of applying an IIR Group delay filter to the IFFT Group Delay filtered step response.

13. The sampled data system of claim 11, wherein the raw step response is generated by averaging a step response over multiple acquisitions of a waveform.

14. The sampled data system of claim 11, further comprising means for correcting a magnitude of the raw step response.

15. The sampled data system of claim 11, wherein the windowing of the impulse response is performed in accordance with a Kaiser-Bessel window.
